(19) United States
(12) Patent Application Publication
(10) Pub. No.: US 2026/0155531 A1
(43) Pub. Date: Jun. 4, 2026

(54) BATTERY SYSTEM WITH MEASURES AGAINST PARTICLE DEPOSITION ON CRITICAL SECTIONS DURING THERMAL RUNAWAY

(71) Applicant: SAMSUNG SDI CO., LTD., Yongin-si (KR)

(72) Inventors: Wolfgang Reinprecht, Attendorf (AT); Fritz HARING, Bruck an der Mur (AT)

(21) Appl. No.: 19/351,152

(22) Filed: Oct. 6, 2025

(30) Foreign Application Priority Data
Dec. 3, 2024 (EP) 24217017.3

(51) Int. Cl. H01M 50/383; B60L 50/64; H01M 10/42; H01M 50/209; H01M 50/249; H01M 50/271

(52) U.S. Cl. CPC H01M 50/383; H01M 10/425; H01M 50/209; H01M 50/249; H01M 50/271; B60L 50/64; H01M 2010/4271; H01M 2220/20

(57) ABSTRACT

A battery module includes: a battery cell stack including a plurality of battery cells stacked along a first direction, each including a case including first and second terminals and a venting outlet therebetween in a terminal side of the case; and a first battery module management unit comprising a first battery module management housing having a base portion and first and second leg portions. The base portion is arranged in front of a first battery cell of the battery cell stack. The first leg portion protrudes from the base portion to cover the first terminal of the first battery cell, and the second leg portion protrudes from the base portion to cover the second terminal of the first battery cell. The venting outlet of the first battery cell is positioned in a gap between the first and second leg portions.

### CROSS-REFERENCE TO RELATED APPLICATION

The present application claims priority to and the benefit of European Patent Application No. 24217017.3, filed on Dec. 3, 2024, in the European Patent Office, the entire disclosure of which is incorporated herein by reference.

### BACKGROUND

### 1. Field

Aspects of embodiments of the present disclosure relate to a battery system with measures against particle deposition on critical sections during thermal runaway.

### 2. Description of the Related Art

A battery pack is a set of any number of (usually identical) battery modules or single battery cells. The battery modules or, respectively, the battery cells, may be configured in a series, parallel, or series/parallel connection configuration to deliver the desired voltage, capacity, and/or power density. Components of a battery pack include the individual battery modules, and the interconnects, which provide electrical conductivity between the battery modules.

Static control of battery power output and charging is not sufficient to meet the power demands of various electrical consumers connected to a battery system. Thus, steady exchange of information between the battery system and the controllers of the electrical consumers is employed. This information includes the battery system actual state of charge (SoC), potential electrical performance, charging ability and internal resistance as well as actual or predicted power demands or surpluses of the consumers. Therefore, battery system usually includes a battery management system (BMS) for obtaining and processing such information on a system level and a plurality of battery module managers (BMMs), which are part of the system's battery modules and obtain and process relevant information on a module level. The BMS usually measures the system voltage, the system current, the local temperature at different places inside a system housing, and the insulation resistance between live components and the system housing. Additionally, the BMMs usually measure the individual cell voltages and temperatures of the battery cells in the battery module.

Thus, the BMS is provided for managing the battery pack, such as by protecting the battery from operating outside its safe operating area (or parameters), monitoring its state, calculating secondary data, reporting that data, controlling its environment, authenticating it, and/or balancing it.

In case of an abnormal operation state, a battery pack should be disconnected from a load connected to a terminal of the battery pack. Therefore, battery systems may further include a battery disconnect unit (BDU) that is electrically connected between the battery module and battery system terminals. Thus, the BDU is the primary interface between the battery pack and the electrical system of the vehicle. The BDU includes electromechanical switches that open or close high-current paths between the battery pack and the electrical system. The BDU provides feedback to the battery control unit (BCU) accompanied to the battery modules, such as voltage and current measurements. The BCU controls the switches in the BDU using low current paths based on the feedback received from the BDU. The main functions of the BDU may include controlling current flow between the battery pack and the electrical system and current sensing. The BDU may further manage additional functions like external charging and pre-charging.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the energy stored is released very suddenly. In extreme cases, thermal runaway can cause battery cells to explode and start fire. In minor cases, it can cause battery cells to be damaged beyond repair.

When a battery cell is heated above a critical temperature (for example, above about 150° C.) the battery cell can transition into a thermal runaway. Generally, temperatures outside of the safe region on either the low or high side may cause irreversible damage to the battery cell and, therefore, may trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in a cell case into the battery pack. The main components of the vented gas are H₂, CO₂, CO, electrolyte vapor, and other hydrocarbons. The vented gas is, therefore, flammable and potentially toxic. The vented gas also causes a gas-pressure to increase inside the battery pack. In the worst case, the high temperatures lead to the process spreading to neighboring cells and fire in the battery pack. At this stage, the fire is difficult to extinguish.

The BMS is critical to the safe operation and optimal performance of rechargeable battery cells and helps reduce or minimize the possibility of thermal runaway. For example, if the BMS detects that the temperature is too high, it can regulate the temperature by controlling cooling fans. However, if the battery cell cannot be cooled and safe conditions restored, the BMS may shut down certain battery cells to protect the entire battery system.

As described before, battery modules and battery systems include multiple battery cells, which may be connected in a serial connection configuration, to achieve a sufficiently high voltage to provide a powerful source of energy for the propulsion of electric vehicles. These battery cells, as well as electrical interconnections and/or voltage sources, are usually insulated with plastic foils providing electrical insulation within the normal operating temperatures up to about 150° C.

However, in case of a malfunction of one or more battery cells or voltage sources, overheating may occur, which causes the insulation barrier to melt, thereby causing a low electrical resistance between parts or components with high differential voltage (typically at least about 20 V), which may cause, in turn, internal short circuits and arcing.

In case of thermal runaway of an individual battery cell, the environment is heated up by the exothermic reaction of the battery cell undergoing a thermal runaway. The amount of energy is determined by the size and chemistry of the battery cell. Therefore, proper thermal insulation from the remaining battery cells of the battery module or battery system should be implemented to stop thermal propagation. The hot debris, which is typically expelled from a battery cell affected by a thermal runaway, usually collects at the edges inside the system housing of the battery system, such as spaces between ends of the battery module and the system housing, where high voltage interfaces are typically accommodated, which may cause electrical short circuits followed by arcing.

### SUMMARY

According to embodiments of the present disclosure, a battery module implemented into a system housing with shielding at spaces between ends of battery cell stacks and the system housing at where high voltage interfaces and further electric wiring is accommodated to protect from hot debris expelled from one or more battery cells affected by a thermal runaway. Further, embodiments of the present disclosure provide a battery system including such protection mechanisms that allows for shielding the spaces between the ends of the battery module and the system housing.

Embodiment of the present disclosure provide a battery module that shields the space between an end of a battery cell stack and a housing of a battery system, when there is a thermal runaway. Further, embodiments of the present disclosure also provide a battery system with the battery module as described above.

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a battery module includes: a battery cell stack including a plurality of battery cells stacked along a first direction; and a first battery module management unit including a first battery module management housing. Each of the battery cells includes a case including a first terminal, a second terminal, and a venting outlet arranged between the first terminal and the second terminal in a terminal side thereof. The first battery module management housing includes a base portion, a first leg portion, and a second leg portion. The base portion is arranged in front of a first battery cell of the battery cell stack when viewed in the first direction. The first leg portion protrudes from the base portion in the first direction and covers the first terminal of the first battery cell, and the second leg portion protrudes from the base portion into the first direction and covers the second terminal of the first battery cell. A gap is formed between the first leg portion and the second leg portion, and the venting outlet of the first battery cell is positioned, along the first direction, in the gap between the first leg portion and the second leg portion.

According to another embodiment of the present disclosure, a battery system includes one or more of the battery modules as described above.

According to another embodiment of the present disclosure, a vehicle includes at least one of the battery modules described above and/or at least one of the battery systems described above.

Further aspects and features of the present disclosure can be learned from the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a perspective view of a related art battery cell.

FIG. 2 is a top view on a related art battery module.

FIG. 3 is a top view of a battery module according to an embodiment of the present disclosure.

FIG. 4 is a top view of an end-portion of the battery module shown in FIG. 3.

FIG. 5 is a cross-sectional view of the battery module shown in FIG. 3.

FIG. 6 is a top view of a battery module according to an embodiment of the present disclosure.

FIG. 7 is a top view of a battery system according to an embodiment of the present disclosure.

FIG. 8A is a lateral view of an end-portion of a battery module according to an embodiment of the present disclosure.

FIG. 8B is a front view of the end-portion of battery module shown in FIG. 8A.

FIG. 9 is a lateral view of an end-portion of a battery module according to an embodiment of the present disclosure.

FIG. 10 is a lateral view of an end-portion of a battery module according to an embodiment of the present disclosure.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, e.g., on a PCB or another kind of circuit carrier. The conducting elements may include metallization, e.g., surface metallizations and/or pins, and/or may include conductive polymers or ceramics. Further electrical energy might be transmitted via wireless connections, e.g., using electromagnetic radiation and/or light.

Further, the various components of these devices may be a processes or threads, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery module includes: a battery cell stack including a plurality of battery cells stacked along a first direction; and a first battery module management unit including a first battery module management housing. Each of the battery cells includes a case including a first terminal, a second terminal, and a venting outlet arranged between the first terminal and the second terminal in a terminal side of the case. The first battery module management housing includes a base portion, a first leg portion, and a second leg portion. The base portion is arranged in front of a first battery cell of the battery cell stack when viewed in the first direction. The first leg portion protrudes from the base portion in the first direction and covers the first terminal of the first battery cell and, in some embodiments, the first terminals of adjacent battery cells. The second leg portion protrudes from the base portion in the first direction and covers the second terminal of the first battery cell and, in some embodiments, the second terminals of adjacent battery cells. A gap is formed between the first leg portion and the second leg portion. Further, the venting outlet of the first battery cell (and of any covered adjacent battery cells) are positioned, along the first direction, in the gap between the first leg portion and the second leg portion.

The first battery module management housing has a U-shape arranged above the battery cell stack, and the legs of the U cover at least some of the terminals. The gap formed between the legs of the U are arranged in the area of the venting valves. Hence, the shape and the placing of the first battery module management housing ensures that each of the venting valves is not covered by the first battery module management housing.

The battery module according to embodiments of the present disclosure provides protection at the regions at an end of the battery cell stack to protect the electrical wiring (such as high voltage interfaces) located there in case of a thermal runaway of one or more of the battery cells, when the battery module is implemented into the housing of a battery system. In other words, a housing of the battery measurement or cell monitoring system (e.g., the battery module management housing) is designed to form a barrier for the debris created by a thermal runaway, which otherwise would be deposited, at least to a major part, on the edge between the battery cell stack and the housing of the battery system at where the electrical wiring is present. Thus, in a battery system equipped with one or more battery modules, the debris is distributed on sections of the battery system with much less likelihood to cause arcing or overheating of other battery cells.

The first terminal, the venting outlet, and the second terminal may be aligned parallel to a second direction perpendicular to the first direction. Each of the terminal sides may be arranged perpendicular to a third direction and may face into the third direction, the third direction being perpendicular to the first direction and the second direction.

The first terminals may be arranged along a straight line extending parallel to the first direction. The second terminals may be arranged along a straight line extending parallel to the first direction. The venting outlets may be arranged along a straight line extending parallel to the first direction.

The gap formed between the first leg portion and the second leg portion may be due to a distance between the first leg portion and the second leg portion, when viewing along the second direction.

The first battery module management unit may further include first battery module management electronics accommodated in the first battery module management housing.

The battery cell stack may include at least two battery cells, at least three battery cells, at least four cells, or at least five battery cells. For example, the battery cell stack may include 10 battery cells, 15 battery cells, 20 battery cells, 25 battery cells, or 30 battery cells.

The first battery module management electronics may be electrically connected to one or more of the battery cells. The first battery module management electronics may be configured to monitor the current and/or the voltage generated by the battery cell stack. The first battery module management electronics may be configured to monitor the current and/or the voltage generated by one or more of the individual battery cells. The first battery module management electronics may be configured to monitor the current and/or the voltage generated by each of the individual battery cells.

One or more of the battery cells may be equipped with a temperature sensor configured to measure the temperature of the respective battery cell. In some embodiments, all battery cells may be equipped with a temperature sensor.

One or more of the battery cells may be equipped with a pressure sensor configured to measure the pressure inside the respective battery cell. In some embodiments, all battery cells may be equipped with a pressure sensor.

The first battery module management electronics may be configured to receive signals from the one or more pressure sensors and/or the one or more temperature sensors. The first battery module management electronics may be configured to evaluate the signals received from the one or more pressure sensors and/or the one or more temperature sensors. The first battery module management electronics may be configured to evaluate, based on the signals received from the one or more pressure sensors and/or the one or more temperature sensors, whether or not one or more of the battery cells are in a state of a thermal event, such as a thermal runaway.

The base portion may have a hollow cuboid shape. The hollow cuboid shape of the base portion may have a first opening in a region at where the first leg portion is connected to the base portion. The hollow cuboid shape of the base portion may have a second opening in a region at where the second leg portion is connected to the base portion. The base portion may extend, with respect to the second direction, over the length of the first battery cell. The first leg portion may have a hollow cuboid shape. The hollow cuboid shape of the first leg portion may be open in an area at where the first leg portion is connected to the base portion. The second leg portion may have a hollow cuboid shape. The hollow cuboid shape of the second leg portion may be open in an area at where the second leg portion is connected to the base portion.

Each of the base portion, the first leg portion, and the second leg portion may include a cavity suitable for accommodating at least a part of the first battery module management electronics. The cavities enclosed by the base portion, the first leg portion, and the second leg portion may be connected such that one continuous cavity is formed in the first battery module management housing.

In one embodiment of the battery module, the first leg portion and the second leg portion have the same extension (e.g., the same length) with regard to the first direction.

The first leg portion may cover only the first terminal of the first battery cell, may cover the first terminals of only the first and the second battery cell, may cover the first terminals of the group of battery cells including only the first, third, and second battery cell, or may cover the first terminals of the group of battery cells including only the first to the forth battery cell in the first direction. In other embodiments, the first leg portion may cover the first terminals of at least the first to the fifth battery cell.

The second leg portion may cover only the second terminal of the first battery cell, may cover the second terminals of only the first and the second battery cell, may cover the second terminals of the group of battery cells including only the first, third, and second battery cell, or may cover the second terminals of the group of battery cells including only the first to the forth battery cell in the first direction. In other embodiments, the second leg portion may cover the second terminals of at least the first to the fifth battery cell.

In one embodiment, the battery module includes a first end plate arranged, when viewed in the first direction, in front of the first battery cell and configured to support the first battery cell with respect to the first direction.

In one embodiment, the battery module includes a second end plate arranged, when viewed in the first direction, behind the last battery cell and configured to support the last battery cell against the first direction.

In one embodiment of the battery module, the first end plate has a prismatic shape. The base portion of the first battery module management housing is arranged on a top face of the first end plate, and the top face faces into a direction perpendicular to the terminal sides of the battery cells.

In one embodiment of the battery module, a first cavity (or interstice) is formed, with regard to a direction perpendicular to the terminal sides of the battery cells, between the first leg portion and the battery cell stack. The first terminals covered by the first leg portion are arranged in the first cavity.

In one embodiment of the battery module, a second cavity (or interstice) is formed, with regard to a direction perpendicular to the terminal sides of the battery cells, between the second leg portion and the battery cell stack, and the second terminals covered by the second leg portion are arranged in the second cavity.

In one embodiment of the battery module, the first leg portion has a wedge-shaped form tapering in the first direction such that a distance between the battery cell stack and a top face of the first leg portion becomes smaller in the first direction.

In one embodiment of the battery module, the second leg portion has a wedge-shaped form tapering in the first direction such that a distance between the battery cell stack and a top face of the second leg portion becomes smaller in the first direction.

The tapering of the first leg portion in the x-direction may be stepless (e.g., continuous) or stepped. Also, the tapering of the second leg portion in the x-direction may be stepless (e.g., continuous) or stepped.

In one embodiment, the battery module further includes a first busbar electrically connected to each of the first terminals, and the first busbar is covered by a first bus bar protection member at least in the area of the first leg portion.

The first busbar may be arranged, in the area of the first leg portion, in the first cavity formed between the first leg portion and the battery cell stack.

In one embodiment of the battery module, the first protection cover includes: a first pedestal part mounted on the terminal sides of at least the battery cells covered by the first leg portion and extending, along the first direction, in a region between the first terminals and the venting outlets of at least the battery cells covered by the first leg portion; and a first flat part arranged on the first pedestal part and extending between the first leg portion and at least the battery cells covered by the first leg portion.

In one embodiment, the battery module further includes a second busbar electrically connected to each of the second terminals, and the second busbar is covered by a second bus bar protection at least in the area of the second leg portion.

The second busbar may be arranged, in the area of the second leg portion, in the second cavity formed between the second leg portion and the battery cell stack.

In one embodiment of the battery module, the second protection cover includes: a second pedestal part mounted on the terminal sides of at least the battery cells covered by the second leg portion and extending, along the first direction, in a region between the second terminals and the venting outlets of at least the battery cells covered by the second leg portion; and a second flat part arranged on the second pedestal part and extending between the second leg portion and at least the battery cells covered by the second leg portion.

In one embodiment, the battery module further includes a second battery module management unit. The second battery module management unit includes a second battery module management housing. The second battery module management housing includes a base portion, a first leg portion, and a second leg portion. The base portion of the second battery module management unit is arranged behind the last battery cell of the battery cell stack, when viewing into the first direction. The first leg portion of the second battery module management unit protrudes from the base portion thereof against the first direction and covers one or more of the first terminals. The second leg portion of the second battery module management unit protrudes from the base portion thereof against the first direction and covers one or more of the second terminals. A gap is formed between the first leg portion and the second leg portion of the second battery module management unit. Each of the venting outlets is positioned, along the first direction, in the gap between the first leg portion and the second leg portion of the second battery module management unit.

The second battery module management unit may further include second battery module management electronics accommodated in the second battery module management housing.

The second battery module management housing may be shaped identically to the first battery module management housing. The second battery module management housing may have a shape that mirrors the shape of the first battery module management housing, for example, by mirroring the shape of the first battery module management housing on a plane perpendicular to the first direction.

The material of the first battery module management housing may be heat resistant up to a temperature range of hot debris generated during a thermal runaway. For example, material of the first battery module management housing may be heat resistant up to a temperature of about 800° C., or for example up to a temperature of about 1000° C., or up to a temperature of about 1200° C., or up to a temperature of at least about 1500° C. Correspondingly, the material of the second battery module management housing may be heat resistant up to the temperature range of hot debris generated during a thermal runaway. For example, material of the second battery module management housing may be heat resistant up to a temperature of about 800° C., or for example up to a temperature of about 1000° C., or up to a temperature of about 1200° C., or up to a temperature of at least about 1500° C.

The material of the first battery module management housing and/or the material of the second battery module management housing may a thermally insulating material. The first battery module management housing and/or the second battery module management housing may be covered, on its outside surface and/or its inside surface, with a thermally insulating material.

The first battery module management housing and/or the second battery module management housing may be made of an electrically insulating material, such as plastic, for example, a heat resistant plastic material.

According to another embodiment, a battery system includes one or more of the battery modules as described above.

A battery system protects the area between the battery cell stack and sidewalls of the battery system housing against hot particle deposition during a thermal runaway event and further against arcing by a specially formed housing of the BMM or cell monitoring system (BMM housing) placed on top of the cell stack.

In one embodiment, the battery system further includes a battery system housing accommodating each of the battery modules. The stack directions of the battery cell stacks of the battery modules are oriented parallel to each other, and each of the battery cell stacks have a first end pointing against the stack direction and a second end pointing into the stack direction. The battery system housing includes a front wall extending perpendicular to the stack direction and a rear wall extending perpendicular to the stack direction. For each of the battery cell stacks, a first space is formed between the first end of the battery cell stack and the front wall and a second space is formed between the second end of the battery cell stack and the rear wall. Each of the battery module management housings arranged at the first ends of the battery modules abuts against the front wall and covers the respective first space.

Also, each of the second battery module management housings arranged at the second ends of the battery modules may abut against the rear wall and cover the respective second space.

In the first space and/or the second space, high voltage interfaces may be accommodated.

In one embodiment of the battery system, any two adjacent battery module management housings with respect to a direction perpendicular to the stack direction of the battery cell stacks are connected to each other with a connection plate.

The battery system housing may further include a bottom wall. For each of the connection plates, a space between the connection plate and the bottom wall may be formed. In some or each of the spaces formed between the connection plates and the bottom wall, module connectors or battery cell stack connectors may be positioned. Then, these module connectors or battery cell stack connectors are protected from hot debris generated in case of a thermal runaway.

According to another embodiment, a vehicle includes at least one battery module as described above and/or at least one battery system as described above.

For example, the vehicle may be a hybrid vehicle or a fully electric vehicle.

According to another embodiment, the at least one battery module as described above and/or the at least one battery system as described above may be provided in an electric device, which may be one of an energy storage system (ESS), an electric scooter, and an electric bike.

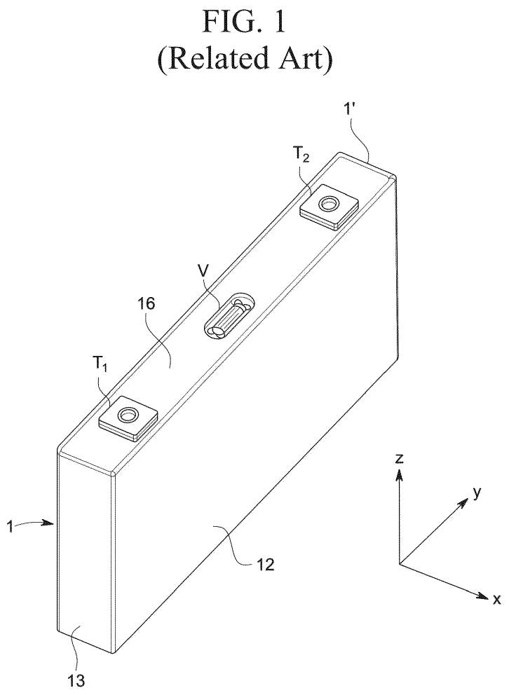

FIG. 1 is a perspective view illustrating a related art battery cell 1 used in, for example, a battery module for an electric or hybrid vehicle. To facilitate the following description, a Cartesian coordinate system with x, y, and z axes is depicted in FIG. 1. The illustrated battery cell 1 has a parallelepiped (e.g., prismatic) shape essentially defined by a case 1′. The case 1′ is, for example, a hardcase, which may be made of a metal material, such as aluminum. The case 1′ may be (or may be formed from) a can or barrel including six essentially planar outer side faces. The case 1′ has a pair of congruent main sides (of that pair, only the side 12 facing into the x-direction is visible in FIG. 1) arranged opposite to each other, each of the main sides being perpendicular to the x-axis. Also, the case 1′ has a pair of congruent lateral sides (of this pair, only the side 13 facing against the y-direction is visible) arranged opposite to each other, each of the lateral sides being perpendicular to the y-axis. The case 1′ also has a lower side (not visible in FIG. 1) and an upper side 16, the lower side and the upper side 16 being congruent and arranged opposite to each other, each of the lower side and the upper side 16 being perpendicular to the z-axis. As can be seen in FIG. 1, the main sides of the battery cell 1 form the battery cell's sides having the largest (or maximal) surface (or surface area).

Because the case 1′ may be made of metal, such as aluminum, it may be electrically conductive. Thus, the case 1′ may be coated by an isolation material (or isolation foil) that provides electrical insulation. However, the isolation material is not thermally robust enough to maintain electric insulation at temperatures of up to about 1000 C and more, which may occur in case of a venting event. As will be described later in more detail, a battery module according to an embodiment of the present disclosure or a battery system according to an embodiment of the present disclosure includes a housing of the BMM or cell monitoring electronics, which is placed at the end of battery cell stacks to protect that areas (when electrical connection is done in a module-wise manner) against particle deposition and the root cause for arcing.

A first terminal T₁ and a second terminal T₂ are arranged on the upper side 16 of the battery cell 1. Accordingly, the upper side 16 will be referred to hereinafter as the “terminal side” of battery cell 1. The terminals T₁ and T₂ allow for electrical connection of the battery cell 1 with an external circuit or device. The first terminal T₁ may be the negative terminal of the battery cell 1, and the second terminal T₂ may be the positive terminal of the battery cell 1. Furthermore, a venting outlet V is arranged on the upper side 16 is arranged between the first terminal T₁ and the second terminal T₂. As shown in FIG. 1, the first terminal T₁, the venting outlet V, and the second terminal T₂ are aligned, in this order, along the y-direction of the coordinate system.

Vent gas can be ejected from (or emitted from) the battery cell 1 through the venting outlet V in case of a thermal event, such as a thermal runaway occurring in the battery cell 1. Inside the battery cell 1, a valve is usually installed upstream of the venting outlet V, and the valve is configured to open (or burst) if the gas pressure inside the battery cell exceeds a reference (or predefined) value and to remain in a closed (or sealed) stated otherwise, that is, when the gas pressure inside the battery cell is below the reference (or predetermined) value. Thus, before being emitted via the venting outlet V, the vent gas may pass the venting valve arranged inside the battery cell 1.

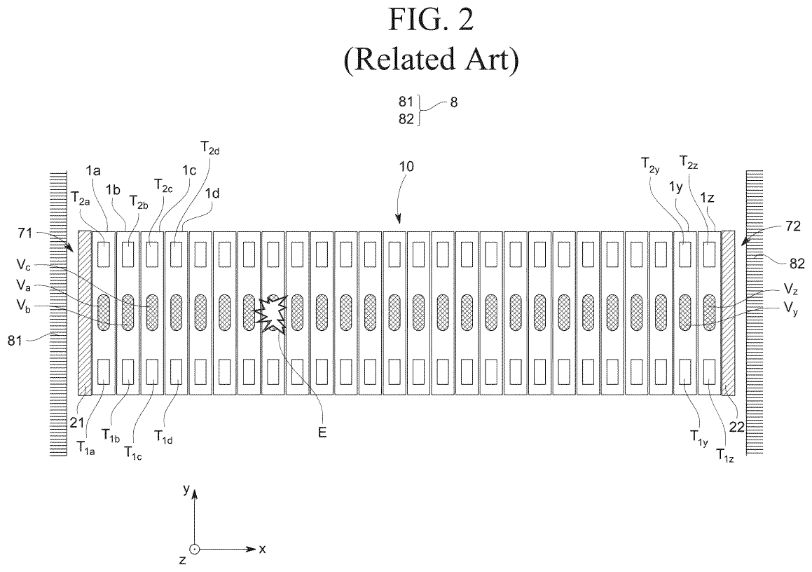

By stacking a plurality of battery cells 1a, 1b, . . . , 1z similar to the battery cell 1 shown in FIG. 1 along a first direction, a stack of battery cells 10 (hereinafter referred to as “battery cell stack” or simply as “stack”) is formed, an example of which is shown in FIG. 2. For example, the first direction (hereinafter referred to as the “stack direction”) may correspond to a direction parallel to the x-axis of the coordinate system in FIG. 1. Then, any one of the individual battery cells 1a, 1b, . . . , 1z may be oriented in the stack 10 such that its main sides each extend perpendicularly to the x-axis of the coordinate system. Typically, a plurality of battery cell stacks is included in a battery system.

In a battery cell stack, neighboring (or adjacent) battery cells may either directly abut against each other or may be spaced apart by cell spacers. Cell spacers can be used to adjust the correct length of a stack. Furthermore, cell spacers (also referred to as “gap fillers”) can inhibit or at least reduce thermal propagation along the stack, for example, in view of the heat generated during a thermal runaway. One or more battery cell spacers may be combined in (or included in) a battery cell stack.

Also, a battery cell stack may be stabilized by end plates. For example, with reference to FIG. 2, a first end plate 21 may be arranged at the front of the first battery cell 1a in the stack 10, as viewed in the stack direction (e.g., the x-direction), thereby providing mechanical support for the first battery cell 1a along the stack direction. Correspondingly, a second end plate 22 may be positioned at the back of the last battery cell 1z in the stack 10, as viewed in the stack direction, thereby providing mechanical support for the last battery cell 1z against the stack direction. The end plates 21, 22 help maintain the alignment of the battery cells 1a, 1b, . . . , 1z, prevent movement, and counteract forces that might cause deformation or dislocation within the battery cell stack 10. For example, the end plates 21, 22 counteract swelling forces generated by the expansion of the battery cells 1a, 1b, . . . , 1z during use, thus preventing deformation and maintaining the alignment of the individual battery cells 1a, 1b, . . . , 1z. This ensures the integrity of the battery cell stack 10, particularly during handling and operation.

The battery cell stack 10 (together with the end plates 21, 22) may be accommodated in a housing 8. The housing 8 is part of the battery module or the battery system that includes the battery cell stack 10. In FIG. 2, a part of a front wall 81 and a part of a rear wall 82 of the housing 8 are illustrated, and the front wall 81 and the rear wall 82 each extend parallel to the y-z-plane of the coordinate system, that is, perpendicular to the drawing plane of FIG. 2. A bottom wall is not shown in FIG. 2 for the sake of simplicity. Between the first end plate 21 and the front wall 81, a first space 71 is formed. Similarly, between the second end plate 22 and the rear wall 82, a second space 72 is formed.

Due to the identical or substantially similar design of the individual battery cells 1a, 1b, . . . , 1z within the stack 10 shown in FIG. 2, the first terminals T₁ₐ, T_{1b}, . . . , T_{1z} of the battery cells 1a, 1b, . . . , 1z are aligned one behind the other in a straight line parallel to the stack direction (e.g., the x-direction). Similar, the second terminals T₂ₐ, T_{2b}, . . . , T_{2z} of the battery cells 1a, 1b, . . . , 1z are aligned one behind the other in a straight line parallel to the stack direction. Also, the venting outlets V in the battery cells 1a, 1b, . . . , 1z are aligned one behind the other in a straight line parallel to the stack direction.

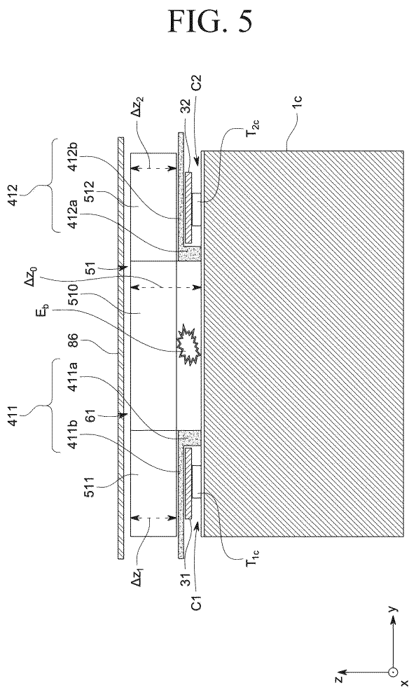

The battery cells 1a, 1b, . . . , 1z may be electrically connected either in series or in parallel. When they are connected in parallel, the first terminals T₁ₐ, T_{1b}, . . . , T_{1z} of the battery cells 1a, 1b, . . . , 1z have the same electrical polarity (e.g., are the negative poles of the battery cells), and each of the second terminals T₂ₐ, T_{2b}, . . . , T_{2z} has the electrical polarity opposite to the polarity of the first terminals T₁ₐ, T_{1b}, . . . , T_{1z} (e.g., the second terminals T₂ are the positive poles of the battery cells). Then, the first terminals T₁ₐ, T_{1b}, . . . , T_{1z} of the battery cells 1a, 1b, . . . , 1z may each be connected to a common first busbar 32 (see, e.g., FIG. 5), while the second terminals T₂ₐ, T_{2b}, . . . , T_{2z} of the battery cells 1a, 1b, . . . , 1z may each be connected to a common second busbar 32 (see, e.g., FIG. 5). The first busbar 31 and the second busbar 32 may then act as the terminals of the entire battery cell stack 10.

Alternatively, when the battery cells 1a, 1b, . . . , 1z of the stack 10 are electrically connected in series, the polarity of the first terminals T₁ₐ, T_{1b}, . . . , T_{1z} alternates along the stack 10, and, correspondingly, the polarity of the second terminals T₂ₐ, T_{2b}, . . . , T_{2z} also alternates along the stack 10. For example, when viewing into the stack direction (e.g., the x-direction), the first terminals T₁ₐ, T_{1c}, . . . , T_{1y} of the battery cells 1a, 1c, . . . , 1y arranged at an odd position in the stack 10 form each a negative pole of the respective battery cell, while the first terminals T_{1b}, T_{1d}, . . . , T_{1z} of the battery cells 1b, 1d, . . . , 1z arranged at an even position in the stack 10 each form a positive pole of the respective battery cell, and, correspondingly, the second terminals T₂ₐ, T_{2c}, . . . , T_{2y} of the battery cells 1a, 1c, . . . , 1y arranged at an odd position in the stack 10 each form a positive pole of the respective battery cell, while the second terminals T_{2b}, T_{2d}, . . . , T_{2z} of the battery cells 1b, 1d, . . . , 1z arranged at an even position in the stack 10 each form a negative pole of the respective battery cell. Then, the battery cells 1a, 1b, . . . , 1z may be electrically linked in a chain-like sequence, where the positive terminal of each battery cell (except for the last battery cell 1z) is connected to the negative terminal of the respective subsequent battery cell. For example, the positive terminal T₂ₐ of the battery cell 1a is connected to the negative terminal T_{2b} of the battery cell 1b. This pattern continues until the positive terminal T_{2y} of the penultimate battery cell 1y in the stack 10 is connected to the negative terminal T_{2z} of the final battery cell 1z. The remaining terminals, that is, the negative terminal T₁ₐ of the first battery cell 1a and the positive terminal T_{1z} of the last battery cell 1z, act as the negative and positive terminals of the entire battery cell stack 10, respectively.

Typically, high voltage interfaces are arranged in (or placed in) the spaces between the ends of a battery stack (the ends, depending on the embodiment, being formed by a battery cell or an end plate) and the respective adjacent walls of the housing accommodating the battery cell stack. Accordingly, in the example shown in FIG. 2, high voltage interfaces may be located in the first space 71 and/or the second space 72. The high voltage interfaces may include module connectors or stack connectors, which connect two adjacent battery modules or battery cell stacks.

In case of a thermal runaway occurring in one or more of the battery cells included in the stack, the hot debris generated and expelled from the affected battery cells is usually located at (or collects at) the edges inside a battery system. Hence, most of the debris will collect in these edge areas of the battery system, such as the above-described spaces between the ends of a battery stack and the respective adjacent walls of the housing. Accordingly, in the example shown in FIG. 2, most of the debris generated by a thermal runaway E (schematically indicated by a flame symbol) occurring in one or more of the battery cells 1a, 1b, . . . , 1z would collect in the first space 71 and/or the second space 72. Hence, if high voltage interfaces are placed in the first space 71 and/or the second space 72, a high risk of electrical short circuits followed by arcing exists.

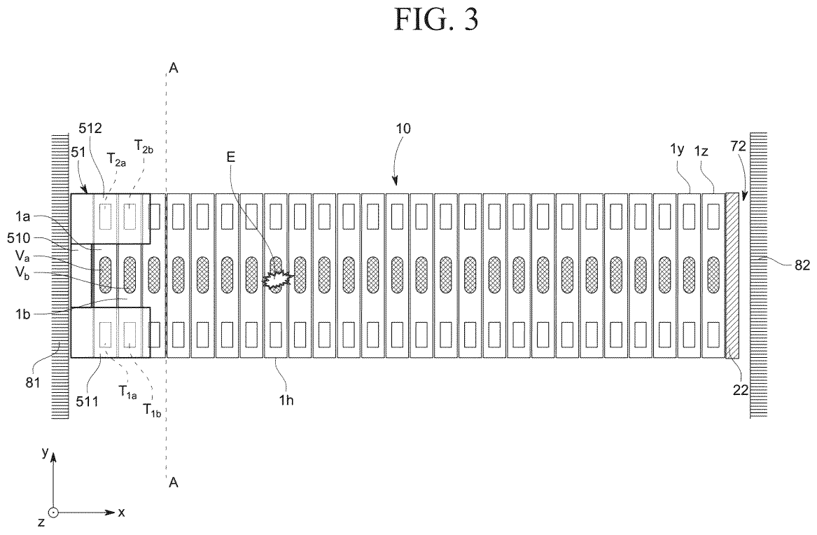

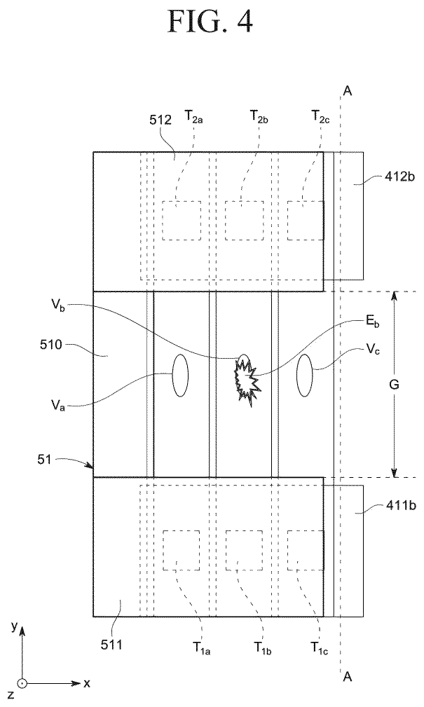

FIG. 3 illustrates a battery module with thermal propagation measures against particle deposition between a battery cell stack and housing at where the high voltage interfaces are located according to an embodiment of the present disclosure. Debris generated by a thermal runaway is usually deposited at the outer edges of the inside of the housing of a battery system. FIG. 3 is a schematic top view of a battery module according to an embodiment of the present disclosure. The battery module shown in FIG. 3 includes a battery cell stack similar to the battery cell stack 10 described with reference to FIG. 2. Additionally, a battery module management (BMM) unit is installed at a first end of the battery cell stack 10, that is, at the battery module's end pointing against the stack direction (e.g., the x-direction). The BMM unit includes a battery module management housing 51 and battery module management electronics accommodated in the BMM housing 51. More detailed views of the BMM housing 51 from different directions are shown in FIGS. 4 and 5.

FIG. 4 is a schematic top view of an end portion of the battery module as shown in FIG. 3. The end portion shown in FIG. 4 includes the BMM housing 51 and, as viewed along the x-direction, the first three battery cells 1a, 1b, 1c of the battery cell stack 10; in other words, FIG. 4 is an enlarged top view of the portion of the battery module depicted in FIG. 3 between the front wall 81 and the virtual dashed line A-A depicted in FIG. 3. FIG. 4 is a top view of a housing of the BMM, which, as will be described in more detail later, protects against particle deposition during a thermal runaway in the region (or area) of high voltage interfaces between the cell stack and the housing.

Further, FIG. 5 is view of the portion of the battery module as shown in FIG. 4 against the x-direction. To illustrate arrangements of members, such as terminals covered by the BMM housing 51, the BMM housing 51 is illustrated as being transparent in the figures providing a top view of the battery module. FIGS. 3 to 5 illustrate the basic concept of thermal propagation measures, which includes protecting the high voltage interfaces at the end of the cell stacks against hot particle deposition during a thermal runaway event.

With respect to the z-direction, the BMM housing 51 is positioned above the battery cell stack 10, as illustrated in FIG. 5. As viewed against the z-direction (see, e.g., FIGS. 3 and 4), the BMM housing 51 has an approximately U-shaped outer appearance including a base portion 510 as well as a first leg portion 511 and a second leg portion 512. Along the x-direction, the base portion 510 is arranged at the front of the first battery cell 1a in the stack 10. Each of the first leg portion 511 and the second leg portion 512 are connected to the base portion 510 and point, from the area of the base portion 510, into the x-direction. With respect to the y-direction, the first leg portion 511 and the second select portion 512 are spaced apart from each other such that a gap G is formed between the first leg portion 511 and the second select portion 512 (see, e.g., FIG. 4).

The gap G between the first leg portion 511 and the second select portion 512 is dimensioned such that, for each of the battery cells 1a, 1b, 1c that are partly covered by the leg portions 511, 512, the respective venting outlets Vₐ, V_{b}, V_{c} are located in the area of the gap G. Hence, in case of a venting event occurring in one of these battery cells 1a, 1b, 1c (e.g., in the second battery cell 1b as indicated by the flame symbol Eₕ in FIG. 4), the vent gas can escape freely upwards (in the z-direction) through the gap G.

At least in the region of the BMM housing 51, a pair of heat resistant protection covers 411, 412 is mounted on top of the battery cell stack 40 to protect the first terminals T₁ₐ, T_{1b}, T_{1c} and the second terminals T₂ₐ, T_{2b}, T_{2c} located in the region of the BMM housing 51 as well as other electrical installations in this region, such as busbars 31, 32 or battery cell control units (CCUs) for monitoring and controlling the status of the respective battery cells, such as the cell voltage or the cell temperature. As can be seen in FIGS. 4 and 5, a first protection cover 411 is mounted in the area of the first terminals T₁ₐ, T_{1b}, T_{1c}, and a second protection cover 412 is mounted in the area of the second terminals T₂ₐ, T_{2b}, T_{2c}.

The first protection cover 411 includes a first pedestal part 411a and a first flat part 411b mounted on top of the first pedestal part 411a. To illustrate that the first terminals T₁ₐ, T_{1b}, T_{1c} are covered by the first flat part 411b, the first flat part 411b (and first leg 511 of the BMM housing 51) are illustrated as being transparent in FIG. 4. The first pedestal part 411a is installed on the terminal sides of the battery cells 1a, 1b, 1c and extends, along the x-direction, between the first terminals T₁ₐ, T_{1b}, T_{1c} and the venting outlets Vₐ, V_{b}, V_{c} of these battery cells 1a, 1b, 1c. With respect to the z-direction, the first pedestal part 411a extends between the terminal sides of the battery cells 1a, 1b, 1c and the first flat part 411b. The first flat part 411b extends parallel to the x-y-plane of the coordinate system over the region of the first terminals T₁ₐ, T_{1b}, T_{1c} and is spaced apart from the terminal sides of the battery cells 1a, 1b, 1c to provide (or to form) a first cavity C1 for the first terminals T₁ₐ, T_{1b}, T_{1c} (and possibly other electrical installations in this region as described above) between the terminal sides of the first three battery cells 1a, 1b, 1c and the first flat part 411b. Thus, the first terminals T₁ₐ, T_{1b}, T_{1c} and the other electrical installations in this region are protected from being polluted by debris expelled from one or more of the battery cells in case of a thermal runaway.

The second protection cover 412 is formed and installed in a symmetrical manner with respect to a virtual mirror plane parallel to the x-z-plane and intersecting the venting outlets Vₐ, V_{b}, V_{c} of these battery cells 1a, 1b, 1c. For example, the second protection cover 412 includes the second pedestal part 412a and a second flat part 412b mounted on top of the second pedestal part 412a. To illustrate that the second terminals T₂ₐ, T_{2b}, T_{2c} are covered by the second flat part 412b, the second flat part 412b (and the second leg 512 of the BMM housing 51) is illustrated as being transparent in FIG. 4. The second pedestal part 412a is installed on the terminal sides of the battery cells 1a, 1b, 1c and extends, along the x-direction, between the second terminals T₂ₐ, T_{2b}, T_{2c} and the venting outlets Vₐ, V_{b}, V_{c} of these battery cells 1a, 1b, 1c. With respect to the z-direction, the second pedestal part 412a extends between the terminal sides of the battery cells 1a, 1b, 1c and the second flat part 412b. The second flat part 412b extends parallel to the x-y-plane of the coordinate system over the region of the second terminals T₂ₐ, T_{2b}, T_{2c} and is spaced apart from the terminal sides of the battery cells 1a, 1b, 1c so as to provide a second cavity C2 for the second terminals T₂ₐ, T_{2b}, T_{2c} (and possibly other electrical installations in this region as described above) between the terminal sides of the first three battery cells 1a, 1b, 1c and the second flat part 412b. Thus, the second terminals T₂ₐ, T_{2b}, T_{2c} and the other electrical installations in this region are protected from being polluted by debris expelled from one or more of the battery cells in case of a thermal runaway.

While the embodiment shown FIG. 4 illustrates that the first protection cover 411 is mounted only in the area of the first terminals T₁ₐ, T_{1b}, T_{1c} of the first three battery cells 1a, 1b, 1c, in other embodiments, the first protection cover 411 may extend, with respect to the x-direction, along the complete (or entire) battery cell stack 10. Then, the first protection cover 411 allows for a protection of each of the first terminals T₁ₐ, T_{1b}, . . . , T_{1z} of the battery cell stack 10. Also, in the embodiment shown in FIG. 4, the second protection cover 412 is mounted only in the area of the second terminals T₂ₐ, T_{2b}, T_{2c} of the first three battery cells 1a, 1b, 1c. However, in other embodiments, the second protection cover 412 may extend, with respect to the x-direction, along the complete (or entire) battery cell stack 10. In such an embodiment, the second protection cover 412 allows for a protection of each of the second terminals T₂ₐ, T_{2b}, . . . , T_{2z} of the battery cell stack 10.

Furthermore, the embodiment of the battery module partly illustrated in FIGS. 4 and 5 includes a first busbar 31 connected to any one of the first terminals T₁ₐ, T_{1b}, . . . , T_{1z} of the battery cell stack 10 and a second busbar 31 connected to any one of the second terminals T₂ₐ, T_{2b}, . . . , T_{2z} of the battery cell stack 10. In the region of the first three battery cells 1a, 1b, 1c, the first busbar 31 is accommodated in the first cavity C1, while, similarly, the second busbar 32 is accommodated in the second cavity C2. Hence, in the area of the BMM housing 51, the first and second busbar 31, 32 are each also protected from debris expelled from one or more of the battery cells of the battery cell stack 10 in case of a thermal runaway by the first and second protection covers 411, 412.

Referring to FIG. 5, the upper faces of the base portion 510, the first leg portion 511, and the second leg portion 512 are flush. However, the extension Δz₀ of the base portion 510 in the z-direction is larger than the extension Δz₁ of the first leg portion 511 and is also larger than the extension Δz₂ of the second leg portion 512. In the illustrated embodiment, the extension Δz₁ of the first leg portion 511 and the extension Δz₂ of the second leg portion 512 are equal (that is, are the same, i.e., Δz₁=Δz₂). By this arrangement, the base portion 510 can be mounted, with its bottom face, at the level of the terminal sides of the battery cells 1a, 1b, . . . , 1z and/or at the level of the top side of the first end plate 21 while the bottom faces of the first leg portion 511 and the second leg portion 512 are each spaced apart, with regard to the z-direction, from the level of the terminal sides of the battery cells 1a, 1b, . . . , 1z. The distance between the level of the terminal sides of the battery cells 1a, 1b, . . . , 1z and the bottom face of the first leg portion 511 is large enough to accommodate the first protection cover 411 within the space between the terminal sides of the first three battery cells 1a, 1b, 1c and the bottom face of the first leg portion 511. Also, the distance between the level of the terminal sides of the battery cells 1a, 1b, . . . , 1z and the bottom face of the second leg portion 512 is large enough to accommodate the second protection cover 412 within the space between the terminal sides of the first three battery cells 1a, 1b, 1c and the bottom face of the second leg portion 512. In the embodiment shown in FIG. 5, the bottom face of the first leg portion 511 abuts against the top face of the first flat portion 411b of the first protection cover 411, and the bottom face of the second leg portion 512 abuts, correspondingly, against the top face of the second flat portion 412b of the second protection cover 412. However, in other embodiments, additional clearances may be provided between the top faces of the flat portions 411b, 412b and the bottom faces of the respective leg portions 511, 512.

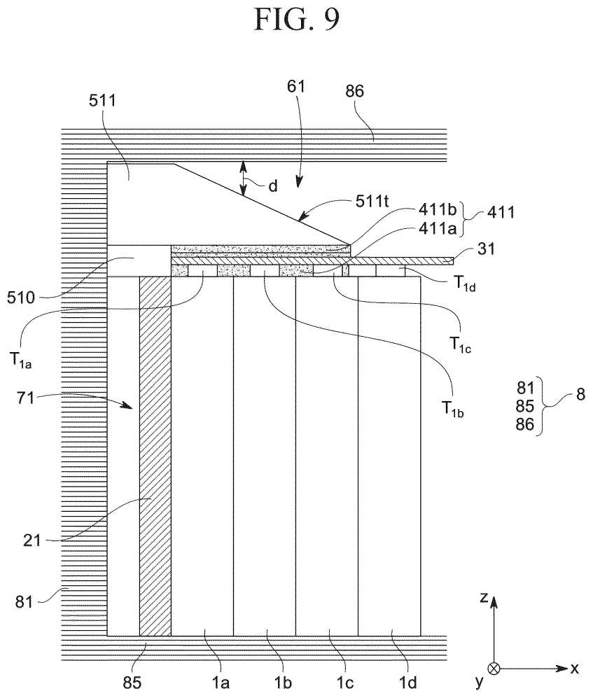

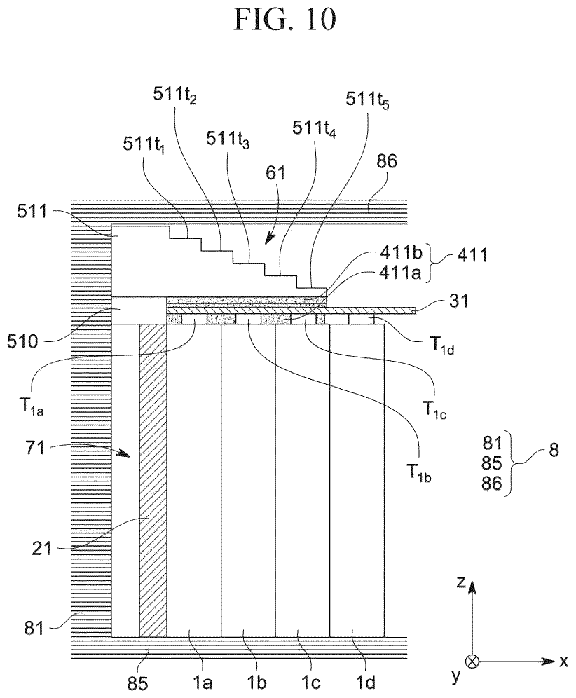

Further, referring to FIG. 5, the housing 8 accommodating the battery module may include a top wall 86 extending above the BMM housing 51 parallel to the x-y-plane of the coordinate system. In the embodiment illustrated in FIG. 5, the top wall 86 is spaced apart from the top surface of the BMM housing 51 such that a clearance 61 is formed between the top wall 86 and the BMM housing 51. Hence, vent gas and debris expelled from one of the battery cells in the area of the gap G between the first leg portion 511 and the second leg portion 512, thus, may escape from the area of the gap G not only into the x-direction but also into and against the y-direction through the clearance 61, which promotes the degassing process. However, in other embodiments, the top wall 86 may abut against the top surface of the BMM housing 51. In some embodiments, the first leg portion 511 and/or the second leg portion 512 may be formed in a wedge-like shape tapering into the x-direction, which further improves the degassing along the y-direction. This is described in more detail below with reference to FIGS. 9 and 10.

In the embodiment shown in FIG. 5, the top face of the first end plate 21 may be flush with the terminal sides of the battery cells 1a, 1b, . . . , 1z. These terminal sides are also flush with each other. Then, because the bottom side of the first leg portion 511 is higher than (e.g., is above) the top face of the first end plate 21, a gap is formed between the first end plate 21 and the first leg portion 511 through which the first busbar 31 can be accessed from the first space 71 formed in front of the first end plate 21 (see, e.g., FIG. 2). Accordingly, high voltage interfaces positioned in the first space 71 can be electrically connected through the before-mentioned gap with the first busbar 31 (and other devices installed on the terminal sides of the individual battery cells 1a, 1b, . . . , 1z, such as temperature sensors and the like). Correspondingly, because the bottom side of the second leg portion 512 is higher than (e.g., is above) the top face of first end plate 21, a gap is also formed between the first end plate 21 and the second leg portion 512 through which the second busbar 32 can be accessed from the first space 71 formed in front of the first end plate 21 (see, e.g., FIG. 2). Accordingly, high voltage interfaces positioned in the first space 71 can be electrically connected through the before-mentioned gap with the second busbar 32 (and other devices installed on the terminal sides of the individual battery cells 1a, 1b, . . . , 1z, such as temperature sensors and the like).

The BMM housing 51 extends along the complete (or entire) width of the battery cell stack 10 in the y-direction (corresponding to the extension of each of its battery cells 1a, 1b, . . . , 1z in the y-direction as illustrated in FIG. 1). Also, as can be seen in FIG. 5, the front faces (the faces facing against the x-direction) of the base portion 510, the first leg portion 511, and the second leg portion 512 are flush in the x-direction.

As described above with reference to FIGS. 3 and 4, the base portion 510 is arranged at the front of the first battery cell 1a when viewing into the x-direction. The extension of the base portion 510 in the x-direction is such that it corresponds to the distance of the front side of the first battery cell 1a (the main side of the first battery cell 1a facing against the x-direction) to the front wall 81 of the housing 8. For example, the base portion 510 together with the rear parts of the leg portions 511, 512 cover the gap along the entire width of the battery cell stack 10 in the y-direction between the rear side of the first battery cell 1a and the front wall 81 at where the first end plate 21 and the first space 71 are located. Accordingly, the first space 71 is shielded against debris expelled from the affected battery cells into the space above the battery cell stack 10 during the occurrence of a thermal runaway by the BMM housing 51. Accordingly, high voltage interfaces (and other electrical installations and/or components) that may be accommodated in the first space 71 are protected from debris, and thus, the risk of electric circuits short circuiting and arcing generated in the voltage interfaces and other electric installations within the first space 71 is avoided or at least largely minimized.

To further prevent debris from entering the first space 71, the lateral sides of the first space 71 can also be closed by lateral plates or barriers extending parallel to the x-z-plane of the coordinate system. Each of the lateral plates or barriers abut with one of the lateral sides of the first battery cell 1a of the battery cell stack 10. In such embodiments, the first space 71 is closed from each side, which provides a maximum protection against debris in case of a thermal runaway.

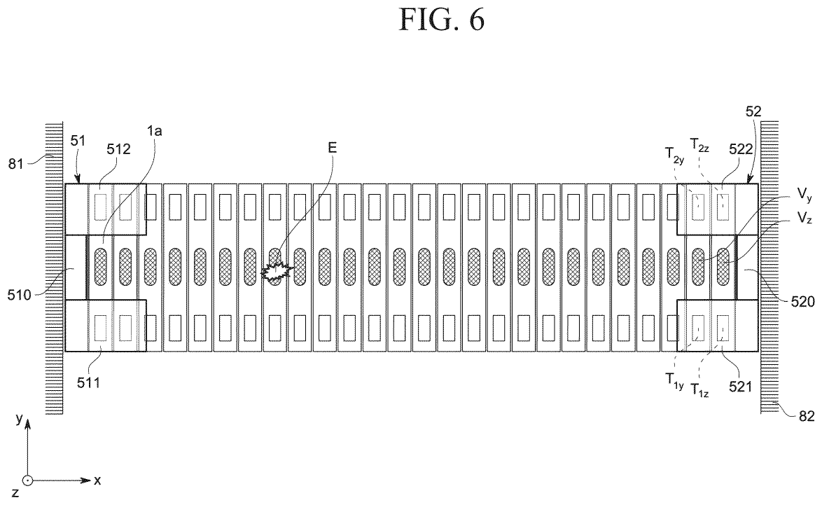

In the embodiment illustrated in FIG. 3, the battery module includes a single BMM unit and, thus, a single BMM housing 51. Accordingly, only the first space 71 (see, e.g., FIG. 2) is protected from debris. In such an embodiment, the second space 72 at the opposite end of the battery cell stack 10 is left unprotected. As long as no sensitive electrical installations are mounted within the second space 72, this is not harmful or detrimental. However, according to another embodiment of a battery module as schematically illustrated in FIG. 6, the battery module includes two BMM units arranged at the opposite ends of the battery module.

The embodiment shown in FIG. 6 is similar to the embodiment shown in FIG. 3 and includes a battery cell stack 10 with a first end plate 21 and a second end plate 22, as shown in FIG. 3, as well as a first BMM unit similar to the BMM unit shown in FIG. 3. The first BMM unit includes a first BMM housing 51 corresponding to the BMM housing 51 shown in FIG. 3, which accommodates first BMM electronics. However, different from the embodiment shown in FIG. 3, the embodiment shown in FIG. 6 includes a second BMM unit including a second BMM housing 52 and second BMM electronics. The second BMM unit is arranged at the second end of the battery cell stack 10, that is, at the end of the battery cell stack 10 opposite to the end where the first BMM unit is installed. The shape of the second BMM housing 52 may be identical to the shape of the first BMM housing 51 (but it may be implemented into the battery module in an orientation rotated by an angle of 180° with regard to an axis parallel to the z-axis of the coordinate system) or may correspond to a mirrored shape of the first BMM housing 51 (e.g., mirrored with regard to a plane parallel to the y-z-plane of the coordinate system).

Accordingly, in the illustrated embodiment, details of the design of the second BMM housing 52 correspond to those of the design of the first BMM housing 51, which has been described above with reference to FIGS. 3 to 5. It is noted, however, that the implementation into the battery module is done in a mirrored or rotated manner. That is to say, the second BMM housing 52 includes a second base portion 520, at the lateral sides of which are arranged two leg portions pointing from the second base portion 520 against the x-direction. For example, a first leg portion 521 of the second BMM housing 52 protrudes from the second base portion 520 into the region above the first terminal T_{1z} of the last battery cell 1z and the first terminal T_{1y} of the penultimate battery cell 1y of the battery cell stack 10, when viewing into the x-direction. Correspondingly, a second leg portion 522 of the second BMM housing 52 protrudes from the second base portion 520 into the region above the second terminal T_{2z} of the last battery cell 1z and the second terminal T_{2y} of the penultimate battery cell 1y of the battery cell stack 10, when viewing into the x-direction. Furthermore, the second BMM housing 52 extends, along the x-direction, between the rear side of the last battery cell 1z (the main side of the last battery cell 1z facing into the x-direction) and the rear wall 82 of the housing 8 as described above with reference to FIG. 2. The second BMM housing 52 is arranged at the same level as the first BMM housing 51 in the z-direction. Thus, the second BMM housing 52 covers the second end plate 22 as well as the void space 72 formed between the second end plate 22 and the rear wall 82 of the housing 8. Accordingly, high voltage interfaces (and other electrical installations) that may, in embodiments of the battery module, be accommodated in the second space 72 are protected from debris generated by a thermal runaway E occurring in one or more of the battery cells 1a, 1b, . . . 1z. Thus, the risk of electric circuits short circuiting and arcing generated in the voltage interfaces and other electric installations within the first space 72 is avoided or at least largely minimized.

To further prevent debris from entering the first space 72, the lateral sides of the first space 72 can also be closed by lateral plates or barriers extending parallel to the x-z-plane of the coordinate system. Each of the lateral plates or barriers abut with one of the lateral sides of the last battery cell 1z of the battery cell stack 10. In such embodiments, the second space 72 is closed from each side, which provides maximum protection against debris in case of a thermal runaway.

The distance between the bottom face of the first leg portion 521 of the second BMM housing 52 and the terminal sides of the last battery cell 1z and the penultimate battery cell 1y in the z-direction is large enough to accommodate the first terminal T_{1z} of the last battery cell 1z and the first terminal T_{1y} of the penultimate battery cell 1y. In embodiments, a first busbar 31 is provided to interconnect the first terminals T₁ₐ, T_{1b}, . . . , T_{1z} of the battery cell stack 10, and the rear end of the first busbar 31 is also accommodated between the bottom face of the first leg portion 521 of the second BMM housing 52 and the terminal sides of the last battery cell 1z and the penultimate battery cell 1y. Further, in embodiments, a busbar protection member may be installed in the region below the bottom face of the first leg portion 521 of the second BMM housing 52 on top of the terminal sides of the last battery cell 1z and the penultimate battery cell 1y. The design and arrangement of this busbar protection member correspond to that already described above as to the heat resistant protection coating (e.g., the first busbar protection member) 411 with reference to FIGS. 4 and 5, noting that the arrangement is mirrored with regard to a plane parallel to the y-z-plane and crosses (e.g., intersects) the center of the battery cell stack 10. In embodiments, the busbar protection member for the first terminals extends along the complete (or entire) battery cell stack 10, and the first busbar protection member 411 below the first BMM housing 51 is an elongated to the rear end of the battery cell stack 10 such that it also forms the busbar protection member below the second BMM housing 52.

Correspondingly, the distance along the z-direction between the bottom face of the second leg portion 522 of the second BMM housing 52 and the terminal sides of the last battery cell 1z and the penultimate battery cell 1y is large enough to accommodate the second terminal T_{2z} of the last battery cell 1z and the first terminal T_{1y} of the penultimate battery cell 1y. In some embodiments, a second busbar 32 is provided to interconnect the second terminals T₂ₐ, T_{2b}, . . . , T_{2z} of the battery cell stack 10, and the rear end of the second busbar 32 is accommodated between the bottom face of the second leg portion 522 of the second BMM housing 52 and the terminal sides of the last battery cell 1z and the penultimate battery cell 1y. Further, in some embodiments, a busbar protection member may be installed in the region below the bottom face of the second leg portion 522 of the second BMM housing 52 on top of the terminal sides of the last battery cell 1z and the penultimate battery cell 1y. The design and arrangement of this busbar protection member correspond to that described above as to the second busbar protection member 412 with reference to FIGS. 4 and 5, with the understanding that the arrangement is mirrored with regard to a plane parallel to the y-z-plane and crossing (e.g., intersecting) the center of the battery cell stack 10. In some embodiments, the busbar protection member for the second terminals extends along the complete (or entire) battery cell stack 10, and the second busbar protection 412 below the first BMM housing 51 is elongated to the rear end of the battery cell stack 10 such that it also forms the busbar protection member below the second BMM housing 52.

In a battery system including two or more battery modules as described above with reference to FIGS. 3 to 6, the module connectors or stack connectors connecting two adjacent modules or battery cell stacks may be prone to hot debris deposition because these module connectors or stack connectors are not protected by the BMM housings as described above. Accordingly, due to the hot venting material depositing on these module connectors or stack connectors, there is an arcing potential as soon as the isolation of the module connectors or stack connectors is burnt away.

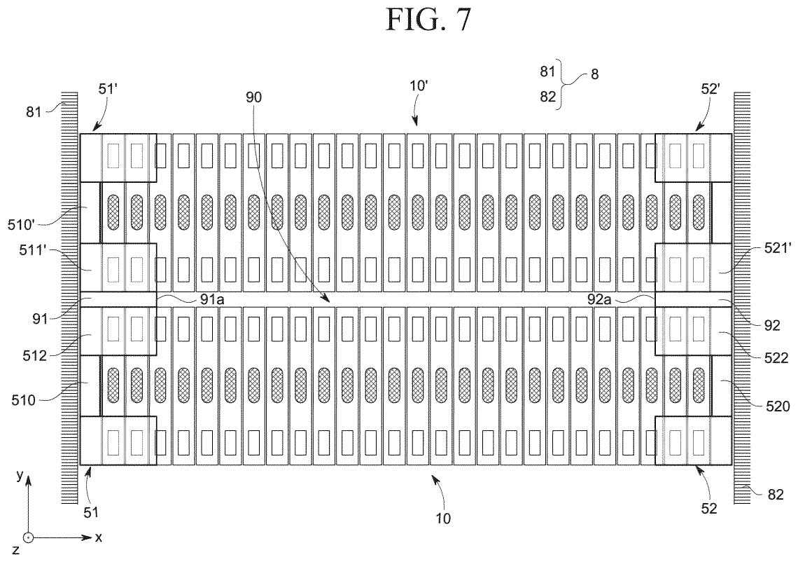

Therefore, two U-shaped BMM housings arranged adjacent to each other can be connected between the respective battery cell stacks via a connection plate. The connection plate covers the stack connector as well as a gap (or possibly a cross beam of the battery pack frame) between the battery cell stacks. An example of such an arrangement is illustrated in FIG. 7, which shows a battery system including a first battery module and a second battery module. The first battery module is identical to the battery module depicted in FIG. 6 and includes a first battery cell stack 10 including a first BMM housing 51 arranged at its front end, as viewed into the x-direction, and a second BMM housing 52 arranged at its second end. The second battery module is also identical to the battery module depicted in FIG. 6 and includes a second battery cell stack 10′ including a further first BMM housing 51′ arranged at its front end, as viewed into the x-direction, and a further second BMM housing 52′ arranged at its second end. The first battery module and the second battery module are arranged in parallel and accommodated within the common housing 8 including the front wall 81 and the rear wall 82. The placing of each of the first and second battery module between the front wall 81 and the rear wall 82 corresponds to the illustration of FIG. 6.

As can be seen in FIG. 7, a first connection plate 91 bridges a gap 90 between the first battery cell stack 10 and the second battery cell stack 10′ in the region of the front ends of the battery modules. The first connection plate 91 extends between the second leg portion 512 of the first BMM housing 51 of the first battery module and the first leg portion 511′ of the further first BMM housing 51′ of the second battery module. Hence, module connectors or stack connectors positioned below the first connection plate 91, when viewing against the z-direction, and connecting the first battery module with the second battery module are protected from debris ejected from one or more of the battery cells of the battery system in case of the thermal runaway.

Correspondingly, a second connection plate 92 bridges the gap 90 between the first battery cell stack 10 and the second battery cell stack 10′ in the region of the rear ends of the battery modules. The second connection plate 92 extends between the second leg portion 522 of the second BMM housing 52 of the first battery module and the first leg portion 521′ of the further second the BMM housing 51′ of the second battery module. Hence, module connectors or stack connectors positioned below the second connection plate 92, when viewing against the z-direction, and connecting the first battery module with the second battery module are protected from debris ejected from one or more of the battery cells of the battery system in case of the thermal runaway.

The shielding of module connectors or stack connectors arranged in the area between the first BMM housing 51 and the further first BMM housing 51′ below the first connection plate 91 can be further improved, in some embodiments, by a connection side plate extending parallel to the y-z-plane of the coordinate system to bridge, along the y-direction, the gap between the first battery cell stack 10 and the second battery cells deck 10′ and, along the z-direction, between the rear end 91a of the first connection plate 91 and the bottom wall of the housing 8. Further, the shielding of module connectors or stack connectors arranged in the area between the second BMM housing 52 and the further second BMM housing 52′ below the second connection plate 92 can be further improved, in some embodiments, by a further connection side plate extending parallel to the y-z-plane of the coordinate system to bridge, along the y-direction, the gap between the first battery cell stack 10 and the second battery cells deck 10′ and, along the z-direction, between the front end 92a of the second connection plate 92 and the bottom wall of the housing 8.

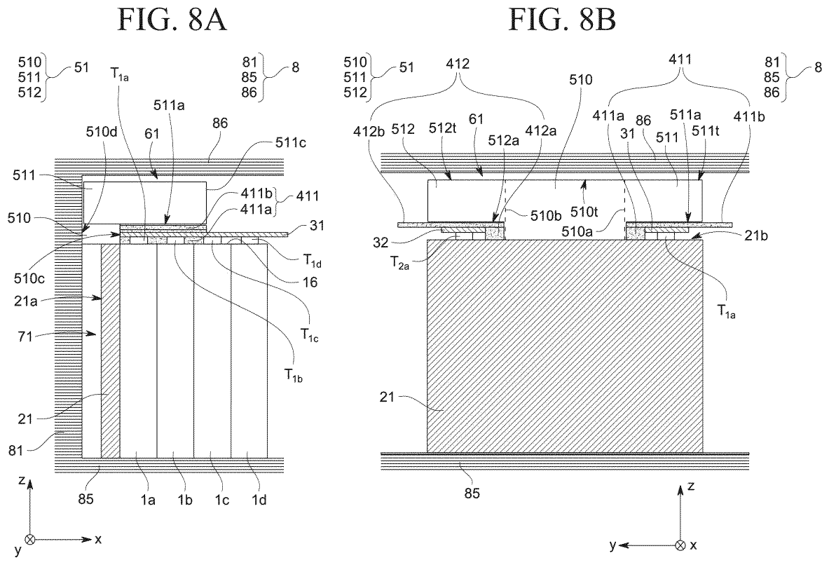

FIG. 8A schematically illustrates a side view of an end portion of a battery module according to an embodiment of the present disclosure. FIG. 8B schematically shows the same end portion but in a front view. The end portion shown in FIGS. 8A and 8B may correspond to the first end portion (the end portion pointing against the x-direction) of a battery module described above with reference to FIGS. 3 to 6. Additionally, referring to FIGS. 8A and 8B, a housing 8 accommodates the battery module to form a battery system. The housing 8 includes, as shown in FIGS. 8A and 8B, a front wall 81, a bottom wall 85, and a top wall 86. The first four battery cells 1a, 1b, 1c, 1d of a battery cell stack that is confined, at its first end, by a first end plate 21 are shown in FIG. 8A. Each of the battery cells 1a, 1b, 1c, 1d and the first end plate 21 is placed on the bottom wall 85 of the housing 8 and extends, in the z-direction, up to the same height such that the upper sides 16 of the battery cells as well as the top face of the first end plate 21 are flush. As can also be seen in FIG. 8A, a void space 71 is formed between the front wall 81 of the housing 8 and a front face 21a of the first end plate 21. Within the space 71, high voltage interfaces may be accommodated.

A BMM unit is arranged on top of the battery cell stack in the region of its first end. The BMM unit includes BMM electronics and a BMM housing 51. The BMM housing 51 includes a base portion 510, a first leg portion 511, and a second leg portion 512. According to the embodiment shown in FIG. 8, the base portion 510 is mounted on the top face 21b of the first end plate 21. The first leg portion 511 is arranged at a lateral side 510a of the base portion 510 facing against the y-direction, while the second leg portion 512 is arranged at an opposite lateral side 510b of the base portion 510 facing into the y-direction. The first leg portion 511 and the second leg portion 512 each extend in the x-direction into a region above the third battery cell 1c of the battery cell stack. Each of the base portion 510, the first leg portion 511, and the second leg portion 512 protrude over the front face 21a of the first end plate 21 against the x-direction to abut against the front wall 81 of the housing 8. Accordingly, the space 71 between the front wall 81 and the first end plate 21 is covered by the BMM housing 51.

As can be seen in FIG. 8A, a first busbar 31 extends along the x-direction and is electrically connected to each of the first terminals T₁ₐ, T_{1b}, T_{1c}, T_{1d} of the battery cells 1a, 1b, 1c, 1d. The first busbar 31 may also be electrically connected to the first terminals of each of the remaining battery cells of the battery cell stack, which are, however, not visible in FIG. 8A. Correspondingly, a second busbar 32 is electrically connected to each of the second terminals of the battery cell stack, which is visible in FIG. 8B with respect to the second terminal T₂ₐ of the first battery cell 1a, as used in the stack direction (e.g., the x-direction).

In the region of the first battery cell 1a and the second battery cell 1b (and, in some embodiments, also the region of the third battery cell 1c), the first busbar 31 is shielded by a first protection cover 411 and the second busbar 32 is shielded by a second protection cover 412. The first protection cover 411 includes a first pedestal part 411a and a first flat part 411b. The first pedestal part 411a is mounted on top of the terminal sides of first battery cell 1a and the second battery cell 1b and partly also on top of the terminal side of the third battery cell 1c in a region between, with regard to the y-direction, the first busbar 31 and a center of these battery cells 1a, 1b, 1c. The first flat part 411b it is arranged on top of the first pedestal part 411a and protrudes from there, against the y-direction, above the first busbar 31 to cover the first busbar 31. The second protection cover 412 includes a second pedestal part 412a and a second flat part 412b. The second pedestal part 412a is mounted on top of the terminal sides of first battery cell 1a and the second battery cell 1b and partly also on top of the terminal side of the third battery cell 1c in a region between, with regard to the y-direction, the second busbar 32 and a center of these battery cells 1a, 1b, 1c. The second flat part 412b it is arranged on top of the second pedestal part 412a and protrudes from there, into the y-direction, above the second busbar 32 to cover the second busbar 32.

In the embodiment shown in FIG. 8A, the first protection cover 411 extends, with respect to the x-direction, between a rear face 510c of the base portion 510 and a rear face 511c of the first leg portion 511. However, in other embodiments, the first protection cover 411 may extend against the x-direction into the region of the base portion 510 (e.g., up to a front face 510d of the base portion 510) and/or in the x-direction into the region behind the rear face 511c of the first leg portion 511. In some embodiments, this may correspondingly apply to the second protection cover 412.

The first busbar 31 is arranged below the first leg portion 511. In the embodiment shown in FIGS. 8A and 8B, the top surface of the first busbar 31 abuts against a bottom face 511a of the first leg portion 511. In other embodiments, the clearance between the top surface of the first busbar 31 and the bottom face 511a of the first leg portion 511 may be left. Further, the second busbar 32 is arranged below the second leg portion 512. In the embodiment shown in FIGS. 8A and 8B, a top surface of the second busbar 32 abuts against a bottom face 512a of the second leg portion 512. In other embodiments, the clearance between the top surface of the second busbar 32 and the bottom face 512a of the first leg portion 512 may be left.

In the embodiment shown in FIGS. 8A and 8B, the top face 510t of the base portion 510, the top face 511t of the first leg portion 511, and the top face 512 t of the second leg portion 512 are flush. However, due to the gaps, along the z-direction, between the level of the terminal sides of the battery cells 1a, 1b, 1c and the level of the bottom faces 511a, 512a of the first and second legs 511, 512, the extension of the base portion 510 along the z-direction is larger than each of the extension of the first leg portion 511 and the extension of the second leg portion 512 along the z-direction. Hence, the base portion 510 protrudes between the first and second select portions 511, 512 against the z-direction up to the top surface 21b of the first end plate 21.

The top wall 86 of the housing 8 extends, parallel to the x-y-plane of the coordinate system, above the BMM housing 51. A clearance 61 may be left between the top of the BMM housing 51 and the top wall 86, as illustrated in FIGS. 8A and 8B. Through the clearance 61, the vent gas and debris can escape from the region between the first and second leg portions 511, 512 in a direction perpendicular to the stack direction. However, in other embodiments, the top of the BMM housing 51 may abut against the top wall 86 of the housing 8. In such embodiments, the first and second leg portions 511, 512 may be shaped differently to allow for escape of debris in direction is perpendicular to the stack direction. Such embodiments will be described below with reference to FIGS. 9 and 10.

In the embodiment shown in FIGS. 8A and 8B, the top face 21b of the first end plate 21 is flush with the terminal sides 16 of the battery cells 1a, 1b, 1c, 1d. In other embodiments, however, the top face 21b of the first end plate 21 may be arranged, with regard to the z-direction, on a level different from the level of the battery cells 1a, 1b, 1c, 1d. In such embodiments, the extension of the base portion 510 along the z-direction may be shortened or lengthened correspondingly such that the base portion 510 may be mounted onto the front face 21a of the first end plate 21 and may extend to the level of the top faces of the first and second leg portions 511, 512.

In the embodiment shown in FIGS. 4, 5, 8A, and 8B, the base portion 510 as well as the first leg portion 511 and the second leg portion 512 each have a cuboid shape. However, it is understood that other shapes can be used. For example, FIG. 9 schematically illustrates an end portion of a battery module according to an embodiment of the present disclosure, which generally corresponds to the end portion illustrated above in FIGS. 8A and 8B. However, in the embodiment shown in FIG. 9, the first leg portion 511 has a wedge-like shape continuously tapering into the stack direction (e.g., x-direction). Hence, a distance D between a top surface 511t of the first leg portion 511 and the top wall 86 of the housing 8 becomes larger in the x-direction. By this arrangement, a clearance 61 having likewise a wedge-like shape is formed between the first leg portion 511 and the top wall 86, through which vent gas and hot debris expelled from one or more battery cells arranged in the region below the leg portions 511, 512 of the BMM housing 51 can escape from the battery cell stack against the y-direction. The second get portion 512 may be formed in a manner corresponding to that of the first leg portion 511. Accordingly, a wedge-shaped clearance is also formed between the second leg portion 512 and the top wall 86 of the housing 8, through which vent gas and hot debris expelled from one or more battery cells arranged in the region below the leg portions 511, 512 of the BMM housing 51 can escape from the battery cell stack into the y-direction. In a top view, the BMM housing 51 shown in FIG. 9 may have a shape similar to that of the first BMM housing 51 shown in FIGS. 3, 4, and 6. In the x-direction, the shape of the BMM housing 51 shown in FIG. 9 maybe similar to the shape of the BMM housing shown in FIG. 8B.

FIG. 10 schematically illustrates an end portion of a battery module according to an embodiment of the present disclosure, which is generally similar to the embodiment described above with reference to FIG. 9. In the embodiment shown in FIG. 10, the first leg portion 511 has a wedge-like shape, thereby tapering in the x-direction. Different from the embodiment shown in FIG. 9, however, the taper is not continuous but formed by a plurality of steps 511t₁, 511t₂, 511t₃, 511t₄, 511t₅. Again, a clearance 61 having a corresponding wedge-like shape (but tapering against the x-direction) is formed between the first leg portion 511 and the top wall 86 of the housing 8. The effect of the clearance 61 in the embodiment shown in FIG. 10 is similar to the effect of the clearance 61 in the embodiment shown in FIG. 9, that is, it allows for improved ventilation of the battery cells 1a, 1b, 1c in the region between the first leg portion 511 and the second leg portion 512. In the embodiment shown in FIG. 10, the second leg portion 512 may be formed in a manner corresponding to that of the first leg portion 511. In a top view, the BMM housing 51 shown in FIG. 10 may have a shape similar to the shape of the first BMM housing 51 shown in FIGS. 3, 4, and 6. In the x-direction, the shape of the BMM housing 51 shown in FIG. 10 maybe similar to the shape of the BMM housing shown in FIG. 8B.

The embodiments illustrated in FIGS. 9 and 10 provide an improved or optimal gas flow perpendicular to the stack direction in the area of the BMM housing 51, which is particularly advantageous for ventilating the first battery cell 1c.

In the afore-described battery module according to embodiments of the present disclosure, end plates 21, 22 have been defined as confining the battery cell stack along the stack direction. However, in other embodiments according to the present disclosure, one or both of the first end plate 21 and the second end plate 22 may be omitted. In such embodiments, the BMM housing may be fixated, that is, on the terminal sides of a first group of battery cells or on top of busbar protections similar to FIGS. 8 to 10. In other embodiments, the BMM housing may be fixated at the housing 8 in which the battery cell stack is accommodated.

### DESCRIPTION OF SOME REFERENCE SYMBOLS

1 battery cell
1′ case
1a, 1b, 1c, 1d, 1h, 1y, 1z battery cells
8 housing of a battery system
10, 10′ battery cell stack
12 main side
13 lateral side
16 terminal side
21 first end plate
21a front face of first end plate
21b top face of first end plate
22 second end plate
31, 32 busbars
51, 51′, 52, 52′ battery module management housings
61 clearance
71, 72 spaces
81 front wall
82 rear wall
85 bottom wall
86 top wall
91 first connection plate
91a rear end of first connection plate
92 second connection plate
92a front end of first connection plate
411 first protection cover
411a first pedestal part
411b first flat part
412 second protection cover
412a second pedestal part
412b second flat part
510, 510′ base portion
510a, 510b, 510c, 510d, 510t faces of the base portion
510t₁, 510t₂, 510t₃, 510t₄, 510t₅ steps
511, 511′ first leg portion
511a, 511c, 511t surfaces of first leg portion
512 second leg portion
512a, 512t faces of second leg portion
520 second base portion
521, 521′ first leg portion of second base portion
522 second leg portion of second base portion
C1, C2 cavities
Δz₀, Δz₁, Δz₂ extensions along the z-direction
d distance
E thermal event (e.g., a thermal runaway)
G gap
T1 first terminal
T₁ₐ, T_{1b}, T_{1c}, T_{1d}, T_{1y}, T_{1z} first terminals
T2 second terminal
T₂ₐ, T_{2b}, T_{2c}, T_{2d}, T_{2y}, T_{2z} second terminals
V venting outlet
Vₐ, V_{b}, V_{c}, V_{y}, V_{z} venting outlets
x, y, z axes of a Cartesian coordinate system

What is claimed is:

1. A battery module comprising:
a battery cell stack comprising a plurality of battery cells stacked along a first direction, each of the battery cells (1a, 1b, . . . , 1z) comprising a case (1′) comprising a first terminal (T₁), a second terminal (T₂), and a venting outlet (V) arranged between the first terminal (T₁) and the second terminal in a terminal side of the case; and
a first battery module management unit comprising a first battery module management housing; the first battery module management housing (51) having a base portion (510), a first leg portion (511), and a second leg portion (512), the base portion (510) being arranged in front of a first battery cell of the battery cell stack (10) when viewed in the first direction (x), the first leg portion (511) protruding from the base portion (510) in the first direction (x) and covering the first terminal of the first battery cell, the second leg portion (512) protruding from the base portion (510) in the first direction (x) and covering the second terminal of the first battery cell,
wherein a gap (G) is formed between the first leg portion (511) and the second leg portion (512), and
wherein the venting outlet of the first battery cell is positioned in the gap between the first leg portion (511) and the second leg portion (512).

2. The battery module as claimed in claim 1, wherein the first leg portion (511) and the second leg portion (512) have the same length in the first direction (x).

3. The battery module as claimed in claim 1, further comprising a first end plate arranged, when viewed in the first direction (x), in front of the first battery cell (1a) and configured to support the first battery cell in the first direction.

4. The battery module as claimed in claim 3, further comprising a second end plate arranged, when viewed in the first direction (x), behind a last battery cell of the battery cell stack (1z) and configured to support the last battery cell (1z) against the first direction (x).

5. The battery module as claimed in claim 3, wherein the first end plate (21) has a prismatic shape, and
wherein the base portion (510) of the first battery module management housing (51) is arranged on a top face (21b) of the first end plate (21), the top face (21b) facing in a direction (z) perpendicular to the terminal sides (16) of the battery cells (1a, 1b, . . . , 1z).

6. The battery module as claimed in claim 1, wherein a first cavity is formed between the first leg portion (511) and the battery cell stack (10), and the first terminal (T₁ₐ, T_{1b}) covered by the first leg portion (511) is arranged in the first cavity in a direction (z) perpendicular to the terminal sides (16) of the battery cells (1a, 1b, . . . , 1z).

7. The battery module as claimed in claim 6, wherein a second cavity is formed between the second leg portion (512) and the battery cell stack (10), and the second terminal (T₂ₐ, T_{2b}) covered by the second leg portion (512) is arranged in the second cavity in the direction (z) perpendicular to the terminal sides (16) of the battery cells.

8. The battery module as claimed in claim 1, wherein the first leg portion (511) has a wedge-shaped tapering in the first direction (x) such that a distance between the battery cell stack (10) and a top face (511t) of the first leg portion (511) becomes smaller in the first direction (x).

9. The battery module as claimed in claim 8, wherein the second leg portion (512) has a wedge-shaped tapering in the first direction (x) such that a distance between the battery cell stack (10) and a top face (512t) of the second leg portion (512) becomes smaller in the first direction (x).

10. The battery module as claimed in claim 1, further comprising a first busbar (31) electrically connected to each of the first terminals (T₁ₐ, T_{1b}, . . . , T_{1z}),
wherein the first busbar (31) is covered by a first protection cover (411) at least in the area of the first leg portion.

11. The battery module as claimed in claim 10, wherein the first protection cover (411) comprises:
a first pedestal part (411a) mounted on the terminal sides (16) of the first battery cell covered by the first leg portion (511) and extending, along the first direction (x), in a region between the first terminal (T₁ₐ, T_{1b}) and the venting outlet (Vₐ, V_{b}) of the first battery cell (1a, 1b) covered by the first leg portion (511); and
a first flat part (411b) arranged on the first pedestal part (411a) and extending between the first leg portion (511) and the first battery cell (1a, 1b) covered by the first leg portion (511).

12. The battery module as claimed in claim 1, further comprising a second busbar (32) electrically connected to each of the second terminals (T₂ₐ, T_{2b}, . . . , T_{2z}),
wherein the second busbar (32) is covered by a second bus bar protection (412) at least in the area of the second leg portion.

13. The battery module as claimed in claim 12, wherein the second protection cover (412) comprises:
a second pedestal part (412a) mounted on the terminal sides (16) of the first battery cell (1a, 1b) covered by the second leg portion (512) and extending, along the first direction (x), in a region between the second terminal (T₂ₐ, T_{2b}) and the venting outlet (Vₐ, V_{b}) of the first battery cells (1a, 1b) covered by the second leg portion (512); and
a second flat part (412b) arranged on the second pedestal part (412a) and extending between the second leg portion (512) and the first battery cell (1a, 1b) covered by the second leg portion (512).

14. The battery module as claimed in claim 1, further comprising a second battery module management unit, the second battery module management unit comprising a second battery module management housing (52),
wherein the second battery module management housing (52) comprises a base portion (520), a first leg portion (521), and a second leg portion (522);
wherein the base portion (520) of the second battery module management housing is arranged behind a last battery cell (1z) of the battery cell stack (10) when viewed in the first direction (x),
wherein the first leg portion (521) of the second battery module management housing protrudes from the base portion (520) thereof against the first direction (x) and covers the first terminal of the last battery cell (T_{1y}, T_{1z}),
wherein the second leg portion (522) of the second battery module management housing protrudes from the base portion (520) thereof against the first direction (x) and covers the second terminal of the last battery cell (T_{2y}, T_{2z}),
wherein a gap is formed between the first leg portion (521) and the second leg portion of the second battery module management housing, and
wherein the venting outlet (V) of the last battery cell is positioned, along the first direction (x), in the gap between the first leg portion (521) and the second leg portion (522) of the second battery module management housing.

15. A battery system comprising a battery module as claimed in claim 1.

16. The battery system as claimed in claim 15, further comprising a battery system housing accommodating a plurality of the battery modules,
wherein the stack direction of the battery cell stacks (10, 10′) in the respective battery modules are oriented parallel to each other, each of the battery cell stacks (10, 10′) having a first end pointing against the stack direction and a second end pointing into the stack direction,
wherein the battery system housing (8) comprises a front wall (81) extending perpendicular to the stack direction and a rear wall (82) extending perpendicular to the stack direction,
wherein, for each of the battery cell stacks (10, 10′), a first space (71) is formed between the first end of the battery cell stack (10, 10′) and the front wall (81) and a second space (72) is formed between the second end of the battery cell stack (10, 10′) and the rear wall (82), and
wherein each of the battery module management housings (51, 51′) arranged at the first ends of the battery modules abuts against the front wall (81) and covers the respective first space (71).

17. The battery system as claimed in claim 16, wherein two adjacent ones of the battery module management housings (51, 51′; 52, 52′) in a direction perpendicular to the stack direction of the battery cell stacks (10, 10′) are connected to each other with a connection plate (91; 91′).

18. A vehicle comprising a battery module as claimed in claim 1.

19. A vehicle comprising a battery system as claimed in claim 15.
